(19) United States
(12) Patent Application Publication
(10) Pub. No.: US 2004/0003383 A1
(43) Pub. Date: Jan. 1, 2004

(54) Stripping of unnecessary information from source code

(75) Inventor: Mario Chenier, Woodinville, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/184,427

(22) Filed: Jun. 28, 2002

(51) Int. Cl. G06F 9/45

(52) U.S. Cl. 717/154; 717/152

(57) ABSTRACT

An automated method and apparatus for stripping unnecessary information from source code. Processing software receives the source code to be stripped and identifies the code elements and the comment elements to be stripped, which are identified by preprocessor macros and comment flags, respectively. The processing software strips the unnecessary code and comment elements and generates stripped source code that may be provided to a build process for generating release versions of the source code.

### FIELD OF THE INVENTION

Aspects of the invention are directed generally to apparatus and methods for processing of source code. More particularly, aspects of the invention relate to techniques for removing unnecessary information, such as code and comments, from a computer program.

### BACKGROUND OF THE INVENTION

Computer programs have become increasingly more complex. Whereas before a single programmer may have been responsible for developing a computer program, today frequently teams of programmers are responsible for developing a given program. Programmers develop a program using one or more high-level languages, such as BASIC, PASCAL, C, C++, etc., which are readily understood by humans. The files containing the computer program in its high-level form is known as source code. The source code for today's computer programs may often exceed hundreds of pages in length. The development process has therefore become more complex.

During the development of a computer program, programmers may write code for various purposes that ultimately is not used in the final product. For example, a programmer may write code that enables a specific feature in the program. If the specific feature, however, is never implemented, the portion of code related to this specific feature would therefore be unnecessary. Developers may also include code in a program for testing or debugging purposes. Once the computer program has been tested and debugged, the test code would be unnecessary in the final product. Similarly for these reasons, programmers also commonly insert comments into the code during the development process that will become unnecessary in the final product.

Once the computer program has been developed and is ready to release, the program may contain significant amounts of unnecessary code and comments that are never utilized. It is therefore desirable to have a preprocessing technique that removes unnecessary information, such as unnecessary source code and unnecessary comments, from a computer program.

### BRIEF SUMMARY OF THE INVENTION

The invention provides a process to remove unnecessary information, such as code and/or comments, from one or more files of a computer program. In accordance with one embodiment of the invention, an automated process is provided for removing various types of information from within files of source code. The process obtains an accurate copy of the source code, for example, as it is stored in source control management. The process utilizes one or more text files that define various preprocessor macros and comment flags within the source code. A strip process is then performed, which removes code that is not enabled as well as comments and files that are flagged to be removed, as defined by the text files. The output of the strip process is a source code with the undesired information stripped out. The stripped source code may then be used, for example, to run a build/test suite pass to do validation of the source code before it is ultimately released.

In another aspect of the invention, a system is provided for performing the automated strip process described above. The invention may be implemented within a general-purpose computing device having computer executable instructions for performing the above-described steps. In one preferred embodiment, the strip process is performed on a build client, which is coupled to a source server that maintains a master copy of the source code, the text files, and the strip process code. In another preferred embodiment, the strip process may be performed on the server or on any client device, or both. The invention may also be utilized to strip other forms of information from the source code including, but not limited to, bug numbers, undesired functionalities, and developer names.

These and other features and aspects of the invention will be apparent upon consideration of the following detailed description of various embodiments of the invention.

### BRIEF DESCRIPTION OF THE DRAWINGS

The foregoing summary of the invention, as well as the following detailed description of embodiments, is better understood when read in conjunction with the accompanying drawings, which are included by way of example, and not by way of limitation with regard to the claimed invention.

FIG. 1 shows a schematic diagram of a general-purpose digital computing environment that can be used to implement various aspects of the invention.

FIG. 2 is a schematic block diagram of a preferred embodiment of the present invention utilizing a distributed software development environment.

FIG. 3 depicts an overall flow diagram of the automated process of the present invention for removing unnecessary information from source code.

FIG. 4 illustrates one preferred embodiment of the automated strip process of the present invention.

FIG. 5 illustrates one preferred embodiment of the strip code process of the present invention.

FIG. 6 illustrates one preferred embodiment of the strip comments process of the present invention.

### DETAILED DESCRIPTION OF THE INVENTION

The exemplary disclosed system and method provide a process to remove unnecessary information, such as code and/or comments, from one or more files of a computer program. In particular, an automated process is provided that, in one preferred embodiment, removes code that is not enabled as well as comments and files that are flagged to be removed. The output of the automated process is source code with the undesired information stripped out.

Although not required, the invention will be described in the general context of computer-executable instructions, such as program modules. Generally, program modules include variables, routines, classes, objects, scripts, components, data structures, and the like that perform particular tasks or implement particular abstract data types. The invention provides for a software system that may be implemented on any network infrastructure such that networked devices may be remotely controlled by, for example, a general-purpose computer, or a system whereby the networked devices may share information with and about each other. The invention provides and accepts common command, control, and communication through the network while retaining the ability of each device to operate autonomously. In a distributed computing environment, program modules may reside on both local and remote devices.

General Purpose Computing Environment

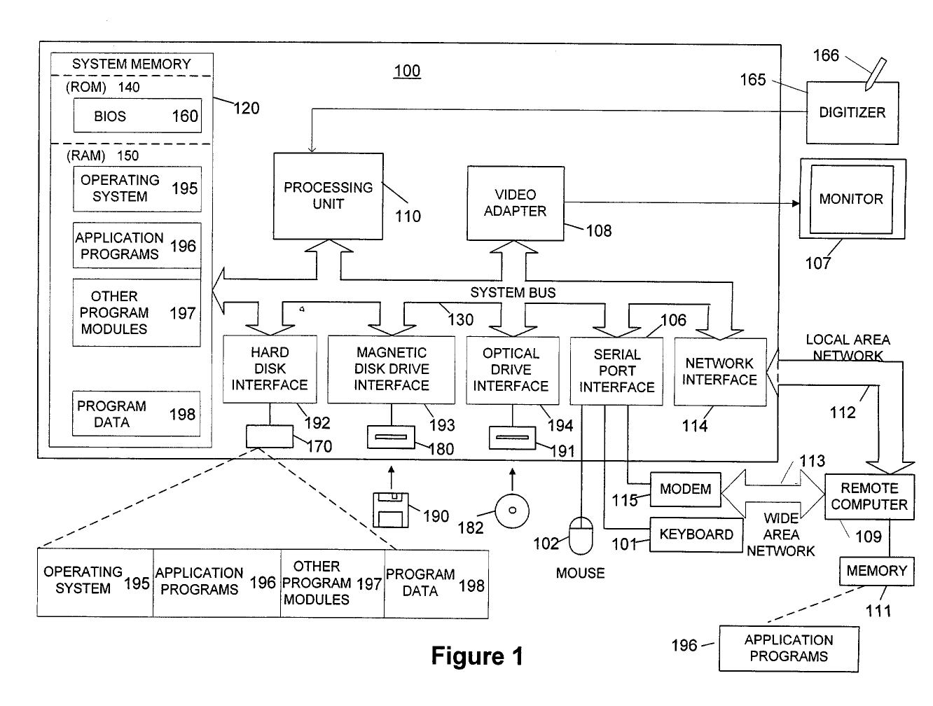

FIG. 1 illustrates a schematic diagram of an exemplary conventional general-purpose digital computing environment that can be used to implement various aspects of the invention. The invention may also be implemented in a simplified version of computer 100, for example without limitation, a hand-held computing device, a tablet PC, or may be an application for use with a more general computing device such as a personal computer. The invention may also be implemented in part of a multiprocessor system, a microprocessor-based or programmable consumer electronic device, a network PC, a minicomputer, a mainframe computer, hand-held devices, and the like. Hand-held devices available today include Pocket-PC devices manufactured by Compaq, Hewlett-Packard, Casio, and others.

Referring still to FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), which is stored in the ROM 140, contains the basic routines that help to transfer information between elements within the computer 100, such as during start-up. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 182 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and/or a pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers. In one embodiment, a pen digitizer 165 and accompanying pen or stylus 166 are provided in order to digitally capture freehand input. Although a direct connection between the pen digitizer 165 and the processing unit 110 is shown, in practice, the pen digitizer 165 may be coupled to the processing unit 110 via a serial port, parallel port or other interface and the system bus 130 as known in the art. Furthermore, although the digitizer 165 is shown apart from the monitor 107, it is preferred that the usable input area of the digitizer 165 be co-extensive with the display area of the monitor 107. Further still, the digitizer 165 may be integrated in the monitor 107, or may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for communicating over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are exemplary and other techniques for establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web server. Any of various conventional web browsers can be used to display and manipulate data on web pages.

Stripping of Unnecessary Information

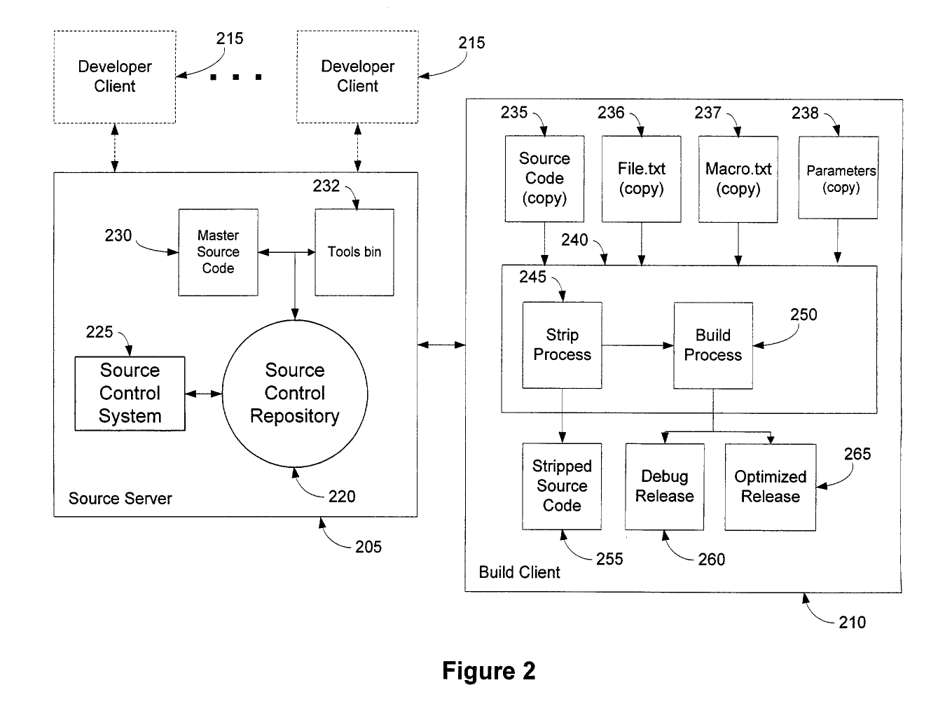

FIG. 2 provides a schematic overview of the various software and hardware components for performing the various stripping aspects of the present invention in accordance with one embodiment of the present invention. FIG. 2 envisions a distributed software development environment where multiple developers may develop code together. The system generally includes a server 205, a build client 210 where the automated strip process of the present invention is performed, and a plurality of client computers 215 where developers may collaboratively work on a software project. Although the automated process is disclosed in this illustration as taking place in the build client 210, it will be appreciated that the automated process may be performed in any number of locations including the server 205, any one of the developer clients 215, or both. The automated process may also be performed on a stand-alone computing device.

In the illustration of FIG. 2, sever 205 comprises a source control repository 220 that has stored therein a master copy of the source code 230 being developed. The source control system 225 allows source code controlled files to be checked into and out of the source code repository 220. In one embodiment, the source control system 225 and the source control repository 220 may comprise the Visual SourceSafe® version control system licensed by Microsoft Corporation of Redmond, Wash. The source control system 225 serves to provide a method of controlling files that require source code control and source control system repository 220 provides a listing of those files that are under source code control. The server 205 also contains a tools bin 232, which may or may be under source code control. The tools bin 232 maintain various files and programs to be used in the automated process including, for example, master copies of text files 235-238 and a master version of strip process code 245 (depicted in FIG. 2 in the build client 210). Before performing the automated process described herein, the build client 210 therefore retrieves updated copies of files in the tools bin 232 and the master source code 230.

As depicted, the build client 210 comprises processing software 240 for performing the strip process and the build process described herein (depicted by strip process code 245 and build process code 250) and a copy 235 of the source code to be stripped. When ready to perform the automated process described herein, the build client 210 may download the master source code 230 (represented as source code (copy) 235) and the strip process code 245 from the server 205. The build client may also download from the server 205 the latest copies of text files from the tools bin 232 (represented as FILE.TXT 236, MACRO.TXT 237, Parameters 238). These text files provide configuration settings for the processing software 240. The processing software 240 executes the strip process code 245 and generates a stripped source code module 255. Similarly, the processing software 240 executes the build process code 250 to generate a debug release 260 and/or an optimized release 265. Each of these elements is described in further detail herein.

As discussed, text files 236-238 provide configuration settings for the processing software 240. Although described as separate files, text files 236-238 may consist of fewer or a greater number of files. Alternatively, text files 236-238 may be part of the processing software 240, the strip process code 245, and/or the build process code 250. The text files 236-238 are described herein.

FILE.TXT 236 is a text file providing information to the processing software 240 regarding how to process various files of the source code 235. For example, FILE.TXT 236 identifies which files in the source code 235 are to be deleted and which are to be copied so they are not processed by the strip process code 245. For example, a binary file, such as an executable file, does not need to be stripped. FILE.TXT 236 may therefore designate all binary files to be directly copied into the stripped source code 255 without any processing.

FILE.TXT 236 also provides information to the processing software 240 regarding how code and comments in the source code 235 should be processed. For example, each programming language may have its own syntax for designating comments. FILE.TXT 236 thereby identifies what comment-stripping syntax are to be utilized for any given file. Similarly, each programming language also uses differing preprocessor macros for identifying code that should be compiled. For example, C++ uses “#if” while assembly files use “ifdev”. FILE.TXT therefore identifies what code preprocessor macros are to be used depending on the programming language used in any given file.

MACRO.TXT 237 is another text file providing information to the processing software 240 regarding how preprocessor macros should be processed (e.g., copied or deleted). MACRO.TXT 237 will have an accounting of all preprocessor macros that are in the source code 235 and will designate how the preprocessor macro should be processed by the strip process code 245. In particular, each preprocessor macro will be categorized as being defined (identifying code that is enabled in the release version of the computer program), undefined (identifying code that is never used in the release version of the computer program), or neither.

The Parameters 238 provides various parameter information for the processing software 240 including for example, the input directory where the source code 235 to be stripped is found, the output directory where the stripped source code 255 is to be stored, instructions whether to strip a command or to replace the command with a comment, whether to add a license tag (namely insert a pointer that identifies a root directory for a location of the license file), and/or how the strip process code 245 should be performed depending on whether the purpose of the stripping is for testing or for building code.

As discussed, the processing software 240 generally includes strip process code 245 and build process code 250. The strip process code 245 is described in further detail herein. The build process code 250 drives various compilers for the various programming languages used in the source code 255 to generate a final executable product. As illustrated, the build process is a process that may generate, for example, a debug release 260 and an optimized release 265. It will be appreciated, however, that other output files can be generated from the build process. The debug release 260 includes additional functionality for testing purposes. For example, the debug release 260 may contain testing, debugging, and/or validation code. The optimized release 265 may not have the functionality for testing purposes and may also be compiled for optimization. The process of the build process code 250 is generally known in the art for processing code for release or testing. Those skilled in the art will therefore appreciate that any number of build processes may be implemented for use with the present invention. For example, in one embodiment, a build process similar to that utilized in the Visual Studio® integrated development environment may be utilized.

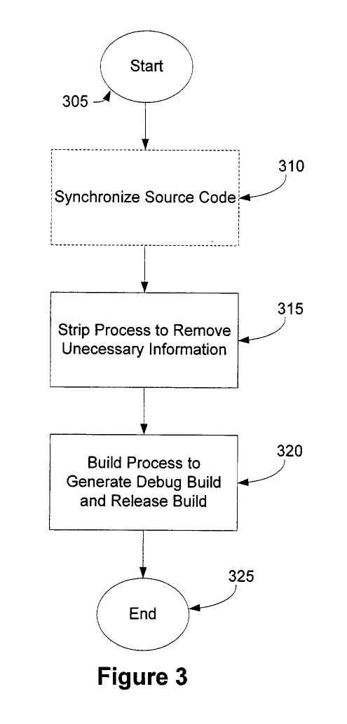

FIG. 3 depicts an overall flow diagram for processing code in accordance with a preferred embodiment of the present invention. The process starts at step 305 and at step 310, the build client 210 obtains a copy of the source code 235 that is synchronized to contain the current version of the files to be processed. For example, in a distributed software development environment illustrated in FIG. 2, the server 205 may contain a master version 230 of the source code under development by various developers. In the embodiment where the build client 210 performs the automated process, the build client 210 obtains a clean copy of the master source code 230. The build client 210 also obtains current or latest copies of the files in the tools bin 232 (FILE.TXT 236, MACRO.TXT 237, Parameters 238, and strip process code 245). Of course, in other embodiments step 310 may be bypassed, for example, where the build client 210 already has this information or where the automated process is performed on the server 205. At step 315, the strip process is initiated to remove unnecessary information, as desired, from the source code 235. The unnecessary information may include, for example without limitation, code, comments, files, bug numbers, undesired functionalities, and programmer names. As disclosed herein, the strip process 315 is a two-step process where code is stripped in the first run and comments are stripped in the second run. At step 320, the build process 250 is initiated to generate a debug release 260 and an optimized release 265.

Strip Process

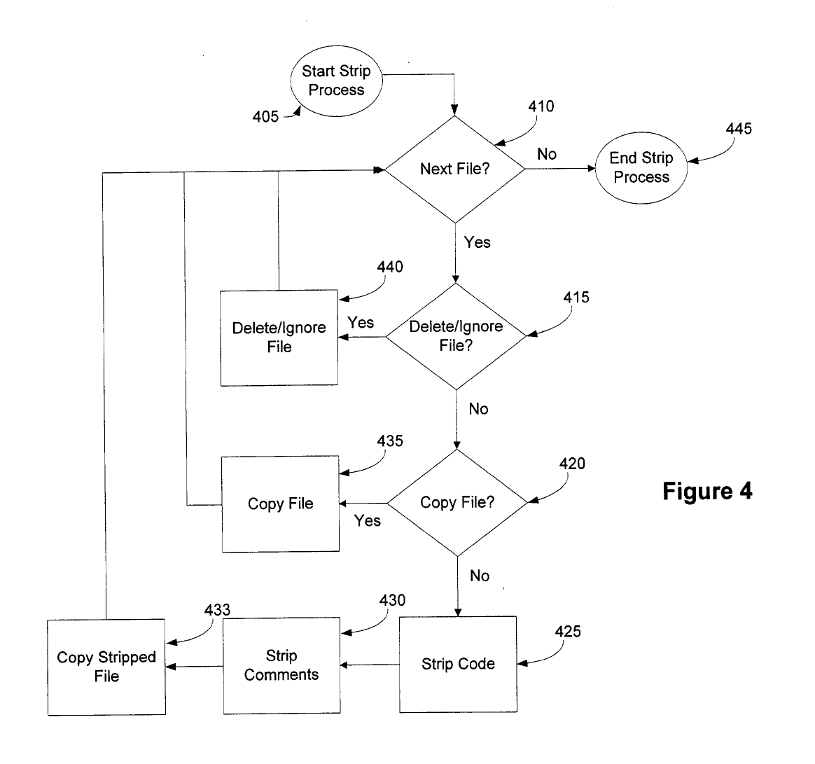

FIG. 4 is a flow diagram depicting the overall strip process 315 in greater detail. The process starts at step 405 and at step 410, the process identifies the first or next file in the source code 230. At step 415, the process determines, based on FILE.TXT 236, whether the file should be deleted or ignored. If FILE.TXT 236 identifies the file as one to be deleted or ignored, the file is deleted or ignored at step 440. The file will therefore not be copied to the stripped source code 255. Going back to step 410, the process identifies the next file. If, on the other hand, the file is not designated by FILE.TXT 236 for deletion or to be ignored, then at step 420, the process determines, based on FILE.TXT 236, whether the file should be copied so that it is in the stripped source code 255 in its entirety. If yes, at step 435, the file is copied into the stripped source code 255 and the process returns back to step 410 to identify the next file. If no, at step 425, the process initiates the actual stripping of code and comments. The stripping process generally consists of two runs of the file. In the first run, at step 425, the process strips code. In the second run, at step 430, the process strips comments. Each of these runs is described in further detail herein. After the code and comments are stripped, at step 433, the processed file is copied into the stripped source code 255 and the process returns back to step 410 to identify the next file. The above process is repeated for each file in the source code 230. The process ends at step 445.

Those skilled in the art will appreciate that the strip code step 425 and the strip comments step 430 may be performed in a single step, in which case the processing software 240 would keep track of whether it was deleting code or comments. It will also be readily appreciated that under either embodiment, the processing software 240 can be configured to perform only the strip code step 425 or perform only the strip comments step 430.

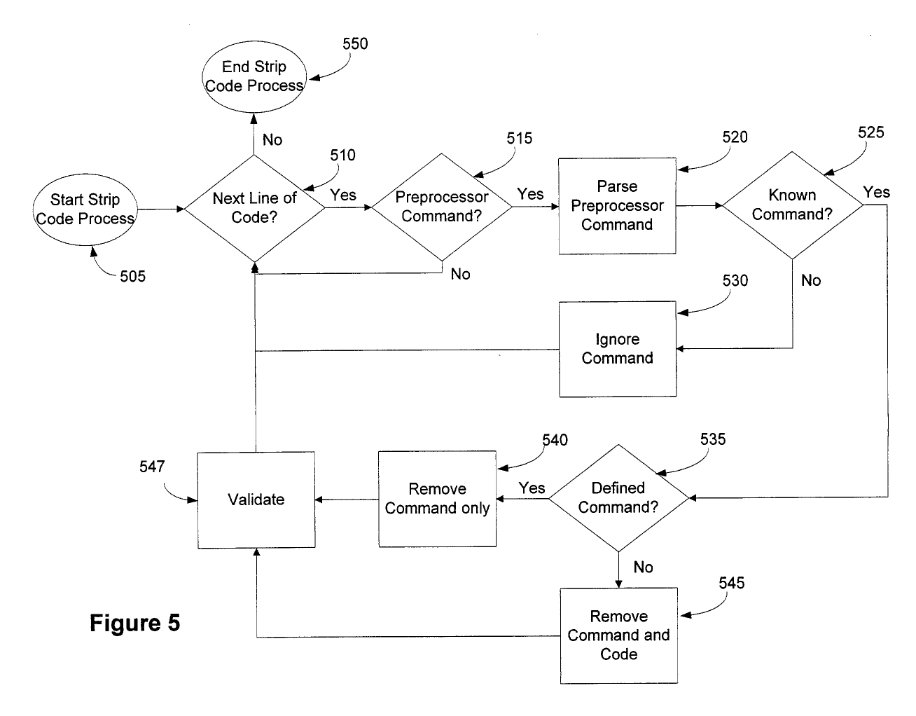

FIG. 5 is a flow diagram depicting the overall strip code process 425 in greater detail. The strip code process 425 receives information from FILES.TXT for preprocessor macro formats and MACROS.TXT to determine whether any particular preprocessor macro is defined. As discussed, a defined preprocessor macro would signify that the associated code is enabled in the release version of the computer program.

The strip code process 425 starts at step 505 with a given file and at step 510 starts reading the file one line at a time. At step 515, the process determines whether the line contains a preprocessor macro. If not, the next line of code is examined at step 510. If a preprocessor macro is present in the line, at step 520, the preprocessor macro is parsed to determine what to do with the code associates with that preprocessor macro. At steps 525 and 535, the process will determine based on MACRO.TXT whether the given preprocessor macro is defined (or enabled), undefined (or not enabled), or neither (unknown). At step 525, if the preprocessor macro is neither (or unknown), the preprocessor macro as well as the associated code will be ignored at step 530 and the next line of code will be examined at step 510. If the preprocessor macro is known, at step 535, the process will determine whether the preprocessor macro is defined or undefined by MACRO.TXT. If the preprocessor macro is defined (or enabled), at step 540, the process will remove the preprocessor macro but will leave the associated code. If, on the other hand, the preprocessor macro is undefined (or not enabled), at step 545, the process removes the preprocessor macro as well as all associated code until the next preprocessor macro is found. Thus, the process may remove multiple lines of code until it identifies the next preprocessor macro.

Under either scenario of step 540 or 545, the process will maintain internal states for the preprocessor macro. For example, the identified preprocessor macro may require information regarding the state of one of the prior preprocessor macros. In the example of C or C++ programming language, such preprocessor macros may include “#else,” “#elseif,” “#endif,” etc. Thus, these preprocessor macros require information regarding whether the “#if” preprocessor macro is defined, undefined, or neither. For example, if the “#if” preprocessor macro was defined, then the “#else” preprocessor macro must be undefined. Thus, in this example, code associated with the “#if” preprocessor macro will remain in the program while code associated with the “#else” preprocessor macro will be removed.

Similarly, under either scenario of step 540 or 545, the process will perform validation to ensure that the remaining code is in proper form. If not, the process may generate an error message. The process returns to step 510, and processes the next line of code as described above. Once the lines of code for a given source code file have been processed as described above, the process stops at step 550.

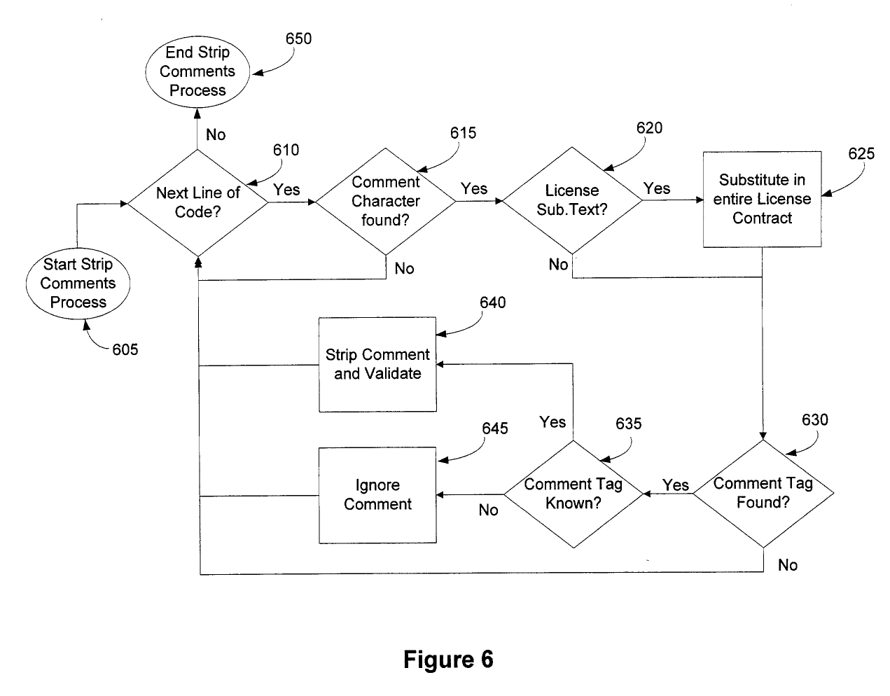

FIG. 6 is a flow diagram depicting the overall strip comments process 430 in greater detail. The strip comment process 430 receives information from FILES.TXT for comment character and flag formats and MACROS.TXT to determine whether any particular comment flag is enabled.

The strip comment process 430 starts at step 605 with a given file and at step 610 starts reading the file one line at a time. At step 615, the process determines whether the line contains a comment character as defined by FILES.TXT. The comment can span multiple lines of code. For example, in C or C++ programming languages, a block comment is denoted by “/*” and “*/.” If so, the process determines whether the comment contains license substitution text. For example, the code may contain a specific comment that references a license. The process may thereby replace the specific comment with the entire license agreement. If not, the process reverts back to step 610 to read the next line of code.

At step 630, the process searches for a comment flag in the comment field. If the process locates a comment flag, at step 635, the process determines whether the comment flag is known as determined by FILES.TXT. If the comment flag is known, at step 640, the process strips the portion of the comment text between an opening comment flag and an ending comment flag. In addition, the comment flags themselves are stripped. Once the comment text and comment flags are stripped, the process performs validation to ensure that the remaining comments are in a proper form. If not, the process may generate an error message. The process also determines whether there are any lines of code that are either empty or only contain a comment character. If so, then those lines are also removed. Referring back to step 635, if the comment flag is not known, at step 645, the process ignores the comment text. Under either case, the process continues its review of the code at step 610. Similarly, at step 630, if no comment flag is found in the code line, the process reverts back to step 610 to process the next line of code in the file as described above. Once all of the lines of code for a given source code file have been processed as described above, the process stops at step 650.

Strip Process Illustrated

The following is an illustration of a portion of C++ source code undergoing the strip process 315 herein described. In this example, it is assumed that the MACRO.TXT 237 defines the preprocessor macro FEATURE_PAL as being enabled. Accordingly, this preprocessor macro will not be stripped from the source code. The following is an exemplary portion of source code to be stripped:

(1) // Code/Comments

(2) #ifdef FEATURE_PAL

(3) //Code/Comments if the PAL Feature is enabled

(4) // <EMAIL> SomeEmailName </EMAIL>

(5) #else

(6) //Code/Comments if the PAL Feature is not enabled

(7) #endif

(8) // Code/Comments after the #if

(9) // Cool Feature <UNDONE>: But we should rename it </UNDONE>

Lines (1)-(8) represent lines of code and/or comments within a source code file. Line (2) uses a “#ifndef” flag to identify a preprocessor macro and lines (5) and (7) are flags that correspond with the “#ifndef” flag. In this example, FILE.TXT 236 has defined the FEATURE_PAL preprocessor macro as true. Accordingly, in the first run of the strip process 314, namely the strip code process 425, the output would generate the following code:

(1) //Code/Comments

(3) //Code/Comments if the PAL Feature is enabled

(4) // <EMAIL> SomeEmailName </EMAIL>

(8) // Code/Comments after the #if

(9) // Cool Feature <UNDONE>: But we should rename it </UNDONE>

Since the FEATURE_PAL preprocessor macro was defined as enabled, lines (3) and (4) were left intact while line (2) identifying the preprocessor macro was removed (step 540). With FEATURE_PAL being defined, it follows that the “#else” preprocessor macro is not defined. Accordingly, lines (5), (6), and (7) were removed (step 545).

The second pass of the strip process 315, namely the strip comments process 430, removes any comments that have been flagged using an XML-like syntax. In this case, FILES.TXT 236 has designated all comments marked with the flags <EMAIL> and <UNDONE> to be deleted from the source code 235. As a result, the strip comments process 430 will remove anything that is between these comment flags. In this example, lines (4) and (9) contain comment deletion flags. In the event that the entire line of the source code starts and ends with a comment deletion flag, the entire source code line will be removed rather than leaving an empty line in the source code. Thus, in this example, where the comment was marked for deletion by the <EMAIL> flag, the strip comment process 430 removed the entire line (4) from the source code 235. The resulting code after the second pass would result in the following source code:

(1) //Code/Comments

(3) //Code/Comments if the PAL Feature is enabled

(8) // Code/Comments after the #if

(9) // Cool Feature

Make files would go through a similar process except that different syntax is used to flag comments and preprocessor macros. For example, the following is an example of a portion of code for a make file:

(1) # Code/Comments

(2) !ifdef FEATURE_PAL

(3) #Code/Comments if the PAL Feature is enabled

(4) # <EMAIL> SomeEmailName </EMAIL>

(5) !else

(6) #Code/Comments if the PAL Feature is not enabled

(7) !endif

(8) # Code/Comments after the #if

(9) # Cool Feature <UNDONE>: But we should rename it </UNDONE>

The make file would be transformed to something like the following after the two-step stripping process:

(1) #Code/Comments

(3) #Code/Comments if the PAL Feature is enabled

(8) # Code/Comments after the #if

(9) # Cool Feature

As illustrated above, the process of the present invention may be utilized for any number of file types including, but not limited to, source code files, make files, and text files.

Although the invention has been defined using the appended claims, these claims are exemplary in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations. For instance, in various embodiments, a certain order to the data has been shown. However, any reordering of the data is encompassed by the invention. Also, where certain units of properties such as size (e.g., in bytes or bits) are used, any other units are also envisioned.

We claim:

1. An automated process for stripping information from source code comprising the steps of:
(a) identifying at least one code element to be stripped from the source code;
(b) identifying at least one comment element to be stripped from the source code;
(c) automatically stripping at least one identified code element and at least one identified comment element from the source code; and
(d) generating a modified source code that does not include the identified code elements and the identified comment elements.

2. The automated process for stripping information of claim 1 further comprising the step of:
(e) automatically removing at least one source code file designated for removal.

3. The automated process for stripping information of claim 1 further comprising the step of:
(e) copying at least one source code file into the modified source code without modification.

4. The automated process for stripping information of claim 1 further comprising the step of:
(e) repeating step (a) to identify each code element within the source code.

5. The automated process for stripping information of claim 1 further comprising the step of:
(e) repeating step (b) for identify each comment element within the source code.

6. The automated process for stripping information of claim 1 further comprising the step of:
(e) generating a debug release from the modified source code.

7. The automated process for stripping information of claim 1 further comprising the step of:
(e) generating an optimized release from the modified source code.

8. The automated process for stripping information of claim 1 wherein steps (a)-(d) are performed on a client computer.

9. The automated process for stripping information of claim 1 wherein steps (a)-(d) are performed on a client computer, which has retrieved a latest copy of the source code from a server computer.

10. The automated process for stripping information of claim 1 wherein steps (a)-(d) are performed on a server computer.

11. The automated process for stripping information of claim 1 wherein the step of identifying at least one code element includes the step of identifying the code element by a preprocessor macro.

12. The automated process for stripping information of claim 11 wherein the step of identifying the code element further includes the step of obtaining information from a macro file regarding how a preprocessor macro should be processed.

13. The automated process for stripping information of claim 1 wherein the step of identifying at least one comment element includes the step of identifying the comment element by a comment flag.

14. The automated process for stripping information of claim 13 wherein the step of identifying the comment element further includes the step of obtaining information from a text file regarding how a comment flag should be processed.

15. A computer-readable medium having computer-executable instructions for performing the steps recited in claim 1.

16. A computer-readable medium having computer-executable instructions that were generated by the process recited in claim 1.

17. A computing device for automatically stripping information comprising in combination:
(a) source code stored in memory of the computing device; and
(b) computer executable instructions for performing the steps of (i) identifying at least one code element to be stripped from the source code; (ii) identifying at least one comment element to be stripped from the source code; and (iii) automatically stripping the at least one identified code element and the at least one identified comment element from the source code.

18. The computing device of claim 17, further comprising:
(c) stripped source code stored in memory which was generated by the computer executable instructions.

19. The computing device of claim 17, wherein the computer executable instructions further comprise instructions for performing the steps of: (iv) generating a stripped source code that does not include the identified code elements and the identified comment elements; and (v) performing a build process on the stripped source code.

20. The computing device of claim 19, further comprising:
(c) optimized release stored in memory which was generated by the build process.

21. The computing device of claim 19, further comprising:
(c) debug code stored in memory which was generated by the build process.

22. The computing device of claim 17, further comprising:
(c) an interface to a server computer for receiving copies of the source code.

23. An automated process for stripping information from a source code comprising the steps of:
(a) identifying at least one preprocessor macro signifying a code element to be stripped from the source code;
(b) identifying at least one comment flag signifying a comment element to be stripped from the source code;
(c) automatically stripping the at least one identified code element from the source code;
(d) automatically stripping the at least one identified comment element from the source code;
(e) generating a modified source code that does not include the identified code elements and the identified comment elements; and
(f) automatically removing at least one file element within the source code designated for removal.

24. The automated process for stripping information of claim 23 further comprising the step of:
(e) copying at least one file element within the source code into the modified source code without modification.

25. The automated process for stripping information of claim 23 further comprising the step of:
(e) repeating step (a) to identify each code element within the source code.

26. The automated process for stripping information of claim 23 further comprising the step of:
(e) repeating step (b) for identify each comment element within the source code.

27. The automated process for stripping information of claim 23 wherein steps (a)-(f) are performed on a client computer.

28. The automated process for stripping information of claim 23 wherein steps (a)-(f) are performed on a client computer, which has retrieved a latest copy of the source code from a server computer.

29. The automated process for stripping information of claim 23 wherein steps (a)-(f) are performed on a server computer.

30. A computer-readable medium having computer-executable instructions for performing the steps recited in claim 23.

31. A computer-readable medium having computer-executable instructions that were generated by the process recited in claim 23.
